(19) United States
(12) Patent Application Publication
(10) Pub. No.: US 2021/0165561 A1
(43) Pub. Date: Jun. 3, 2021

(54) MODEL GENERATION BASED ON SKETCH INPUT

(71) Applicant: Hewlett-Packard Development Company, L.P., Spring, TX (US)

(72) Inventors: Jishang Wei, GUILFORD, CT (US); Zhiyuan Li, Palo Alto, CA (US); Rafael Ballagas, Palo Alto, CA (US)

(73) Assignee: Hewlett-Packard Development Company, L.P., Spring, TX (US)

(21) Appl. No.: 17/045,776

(22) PCT Filed: Jun. 11, 2018
(86) PCT No.: PCT/US2018/036840

§ 371 Date: Oct. 7, 2020

(51) Int. Cl. G06F 3/0484; G06T 19/20; G06N 3/04; G02B 27/01

(52) U.S. Cl. CPC G06F 3/04845; G02B 27/0172; G06N 3/0454; G06T 19/20

(57) ABSTRACT

An example system includes a sketch interface to receive a sketch input from a user, an object model reservoir to store models of objects, a generator to generate additional models of objects, and a sample matching portion. The additional models generated by the generator are to be added to the object model reservoir. The sample matching portion is to select at least one matched object model from the reservoir to match to the sketch input from the user. The generator is to generate the additional models based on the matched object model.

### BACKGROUND

Design of objects is often facilitated by tools which allow user input to create a model of the desired object. For example computer-aided design tools allow a user to create a three-dimensional object model and display the object model in two dimensions (e.g., plan view) or three dimensions (perspective view). The user may create edges or surfaces of the desired object model and change the features. Creating the object model in such a tool may precede and facilitate production of the three-dimensional object.

### BRIEF DESCRIPTION OF THE DRAWINGS

For a more complete understanding of various examples, reference is now made to the following description taken in connection with the accompanying drawings in which:

FIG. 1 illustrates an example system for generation of a model based on a sketch input from a user;

FIG. 2 illustrates another example system for generation of a model based on a sketch input from a user;

FIG. 3 is a flowchart illustrating an example method for model generation;

FIG. 4 is a flowchart illustrating another example method for model generation; and

FIG. 5 illustrates a block diagram of an example system with a computer-readable storage medium including instructions executable by a processor for model generation.

### DETAILED DESCRIPTION

As noted above, tools for designing of an object allow a user to generate an object model. Creation of a model using such tools typically calls for a level of expertise from the user. Further, creation of an accurate model can be time consuming and inefficient.

Various examples described herein relate to generation of a shape or a model of an object based on a sketch provided by a user. In various examples, a three-dimensional model of an object may be provided to a user based on a 2- or 3-dimensional sketch. Example systems are provided with a user interface that allows a user to input a sketch, such as on a 2D plane or a 3D virtual reality input, for example. The input sketch may be used to match a model of an object in a object model reservoir, or database. In various examples, the system includes a generator which uses an artificial intelligence (AI) agent to generate models which are not in the reservoir and may add the additional models generated to the reservoir. In one example, the generator uses an input, such as the matched model for the sketch input by the user, and converts the input into a latent vector. The generator processes the vector and outputs a binary 3D matrix which can represent different objects. A discriminator may be provided to filter out unrealistic models. In some examples, the system may iteratively select a matching object after the addition of newly generated objects to the reservoir. In some examples, the discriminator is activated during a training phase and is de-activated during operation with user input.

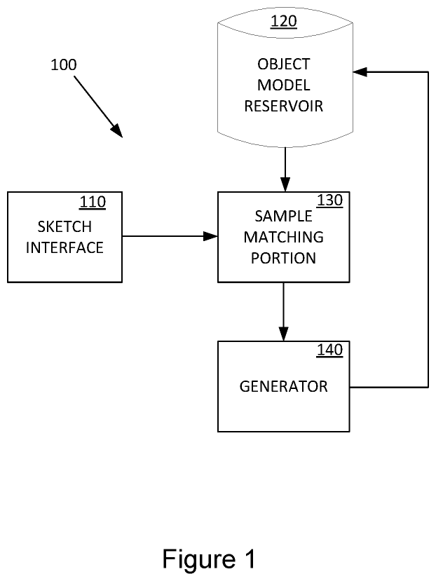

Referring now to the Figures, FIG. 1 illustrates an example system 100 for generation of a model based on a sketch input from a user. The example system 100 of FIG. 1 includes a sketch interface 110. The sketch interface 110 is provided to receive a sketch input from a user, allowing the user to, for example, draw a sketch of a desired object. Thus, an untrained user may be able to provide an input to the example system 100. In various examples, the sketch interface 110 may be an electronic pad, such as a tablet or a touch-sensitive screen, to allow a user to provide a sketch on a two-dimensional surface. In other examples, a three-dimensional input may be provided through, for example, a virtual-reality interface.

The example system 100 is further provided with an object model reservoir 120. The object model reservoir 120 may be a database or other store of electronic models of various objects. The reservoir 120 may include any practical number of models, and the models may be stored in categories of objects. For example, the models may be stored in separate libraries corresponding to categories such as airplanes, automobiles, buildings, etc. In some examples, the object model reservoir 120 includes models of three-dimensional objects stored therein. For example, the reservoir 120 may include voxel representations of various three-dimensional objects.

In the example system 100 illustrated in FIG. 1, a sample matching portion 130 is provided to identify and/or select at least on object model from the object model reservoir 120 as a match for the sketch input provided through the sketch interface 110. In various examples, the sample matching portion 130 is provided with logic to extract features from the sketch input provided by the user. The extracted features may include components such as lines, edges, surfaces or other two-dimensional or three-dimensional shapes. The sample matching portion 130 may then compare the extracted features with features of models in the object model reservoir 120. In this regard, the sample matching portion 130 may identify one model in the reservoir 120 as the best match or may select multiple models as appropriate matches.

The example system 100 of FIG. 1 further includes a generator 140 to generate models of objects in addition to those already in the object model reservoir 120. In this regard, the generator 140 may generate additional models based on an object selected by the sample matching portion 130 as a match for the sketch input provided by the user. As described in greater detail below, in some examples, the generator 140 may include, or be a part of, an artificial intelligence (AI) agent provided to generate the additional models.

The additional models generated by the generator 140 may then be added to the object model reservoir 120. Additionally, in some examples, certain models added in a previous iteration may be removed from the object model reservoir 120. For example, the lowest scoring models or models with a score below a secondary threshold may be deleted. In some examples, the sample matching portion 130 may perform further matching of the sketch input from the sketch interface 110 with models in the object model reservoir 120, including the additional models generated by the generator 140. Further, the sample matching portion 130 may update the matching based on updated sketch input. For example, a user may first sketch an airplane including the fuselage and wings only. The sample matching portion 130 may perform a comparison and identify a best match from the object model reservoir 120. When the user adds jet engines or propellers to the sketch, the sample matching portion 130 may update the match.

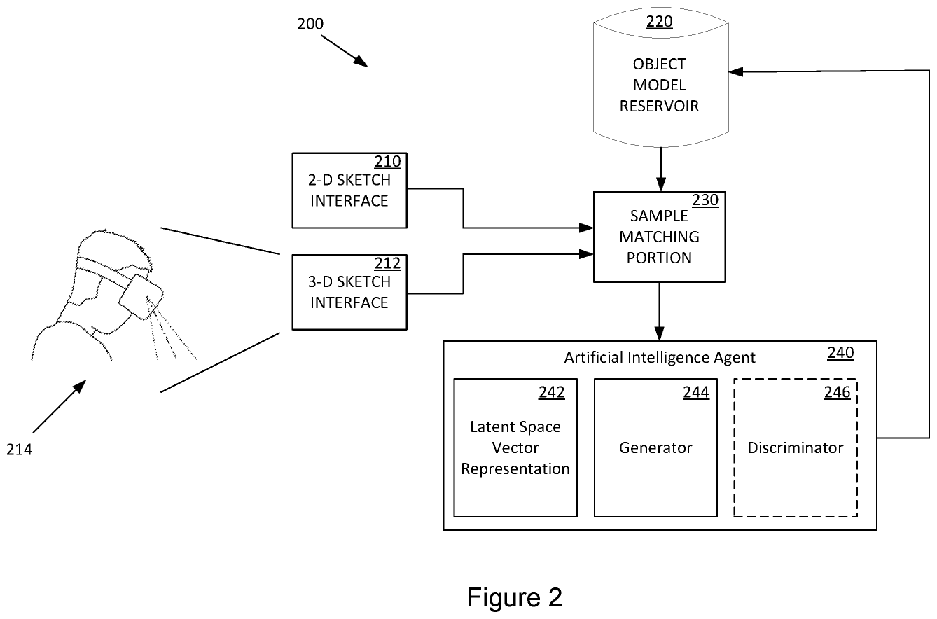

Referring now to FIG. 2, another example system 200 for generation of a model based on a sketch input from a user is illustrated. The example system 200 of FIG. 2 is similar to the example system 100 of FIG. 1 described above and includes sketch interfaces 210, 212, an object model reservoir 220 and a sample matching portion 230. In the example system 200 of FIG. 2, a two-dimensional sketch interface 210 and a three-dimensional sketch interface 212 are provided. As noted above, the two-dimensional sketch interface 210 may allow a user to sketch an input on a two-dimensional surface, such as a touch screen. The three-dimensional sketch interface 212 includes a virtual reality (VR) system with a head-mounted display (HIVID) 214 that may be worn by a user. As used herein, VR systems may include augmented reality systems. The HIVID 214 may allow the user to input a three-dimensional sketch. For example, a user may create a three-dimensional sketch using gestures with his/her hands, which may have tracked controllers (not shown). The user can draw in three dimensions and rotate the model being drawn using the VR capabilities.

The example system 200 of FIG. 2 includes an artificial intelligence (AI) agent 240 to provide additional models generated based on a matched object from the object model reservoir 220. The AI agent 240 of the example system 200 includes a latent space vector representation 242, a generator 244 and a discriminator 246.

The latent space vector representation 242 of the AI agent 240 is provided to generate a vector representation of latent space around the object model match output by the sample matching portion 230. In various examples, the latent space vector may be generated from a voxel representation of the object model match. In this regard, various latent space vectors may be sampled around the input latent space vector which the generator 244 used to generate the matched object model. For example, the sample matching portion 230 may provide a 64×64×64 binary voxel representation of the matched object.

In one example, the latent vector is determined as:

z−Alpha*z+(1−Alpha)*t,

where Alpha is an interpolation rate, z is the current latent vector, and t is one of the anchor latent vector for a category of object (e.g., aircraft). In one example, Alpha is set at 0.8. In other examples a different value of Alpha between 0 and 1 may be selected.

The generator 244 may use the latent space vector to generate additional models. In one example, the generator 244 takes random N-dimensional vectors and turns them into 3D volumetric objects. For example, generator may use convolution layers to generate additional 64×64×64 binary matrices from the latent space vector. Each 64×64×64 matrix may represent an additional candidate model.

In one example, the AI agent may be trained in an offline mode using a generative adversarial neural network (GAN). In this example, the generator 244 and the discriminator 246 act as a balance to each other. The discriminator 246 may be provided to eliminate selected 3-D representations as unrealistic. For example, certain candidate models generated by the generator 244 may be difficult or impossible to exist. As an example, the generator 244 may generate a candidate model that has a component (e.g., a wing) detached from the main body (e.g., aircraft fuselage). The discriminator 246 can recognize and eliminate such candidates before they are added to the object model reservoir 220.

In one example, the elimination of candidate models by the discriminator 246 may be based on a confidence value generated by the discriminator. The discriminator uses the matrix (e.g., the 64×64×64 voxel representation) output by the generator 244 and outputs a real number between 0 and 1 which may be used as the confidence value. A threshold value may be selected to determine whether the voxel representation is to be added to the object model reservoir 220 or is to be eliminated.

In various examples, the adversarial relationship between the generator 244 and the discriminator 246 may be exploited during a training phase, or an offline mode. The training may continue until the discriminator 246 is unable to distinguish the object models generated by the generator 244 from various reference objects. During an online mode, such as during receipt of an input sketch from a user, the discriminator 246 may be de-activated, allowing the generator to generate object models at an increased rate which may be appropriate for interactive operation with the user. Accordingly, FIG. 2 illustrates the discriminator 246 with a dashed line to indicate its role in different modes (online versus offline).

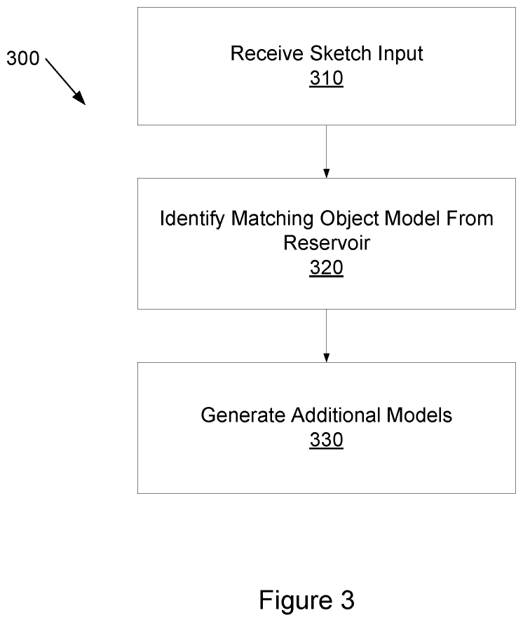

Referring now to FIG. 3, a flowchart illustrating an example method for model generation is provided. The example method 300 of FIG. 3 may be implemented in the example systems 100, 200 described above with reference to FIGS. 1 and 2. The example method 300 includes receiving a sketch input from a user (block 310). As described above, with reference to FIGS. 1 and 2, the sketch input may be received from a user through a sketch interface. The sketch interface may be a two-dimensional input (e.g., touch screen) or a three-dimensional input (e.g., VR system).

The example method 300 further includes identifying a matching object model for the sketch input from a reservoir of object models (block 320). In this regard, features may be extracted from the sketch input and compared with features of various models in the reservoir of object models. A best match or multiple candidate matches may be provided as a result of the matching.

The example method 300 further includes generating additional models of objects (block 330). In various examples, the generation of additional models may be based on the matching object model identified in block 320. As described above, the generation of additional models may be facilitated by an AI agent.

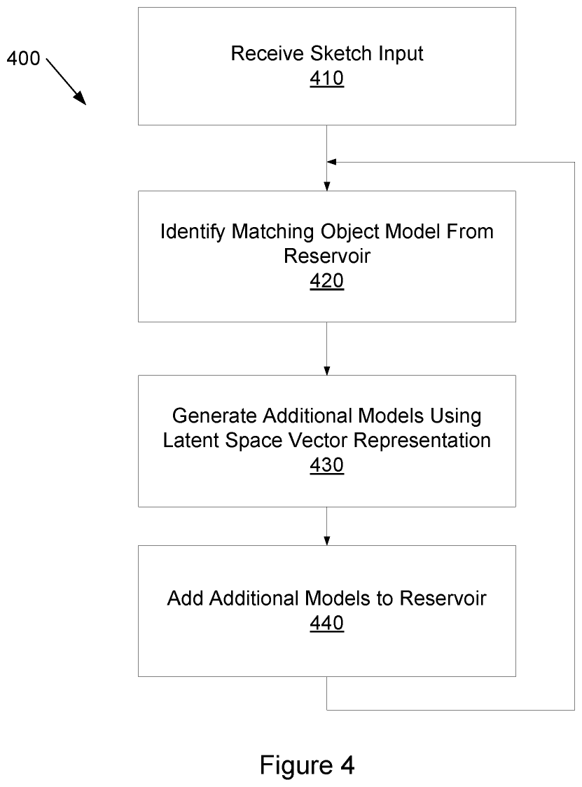

Referring now to FIG. 4, a flowchart illustrating another example method for model generation is illustrated. The example method 400 of FIG. 4 is similar to the example method 300 of FIG. 3 and may be implemented in the example systems 100, 200 described above with reference to FIGS. 1 and 2. The example method 400 includes receiving a sketch input from a user (block 410). As described above, the sketch input may be received from a user through a sketch interface which may be a two-dimensional or a three-dimensional input.

The example method 400 further includes identifying a matching object model for the sketch input from a reservoir of object models (block 420). As described above, features may be extracted from the sketch input and compared with features of various models in the reservoir of object models, and a best match or multiple candidate matches may be provided as a result of the matching.

The example method 400 further includes generating additional models of objects using a latent space vector representation (block 430). As described above with reference to the example system 200 of FIG. 2, an AI agent may use a latent space vector representation to generate additional models and, using a discriminator, may eliminate unrealistic models.

The additional models generated using the latent space vector representation, after elimination of the unrealistic models, are then added to the reservoir (block 440). The process may then return to block 420 and iteratively repeat the steps. In this regard, additional models may be generated and added to the reservoir in an offline mode. For example, the process may continue even after the user has been provided with a best match to continue to generate additional models and add them to the reservoir.

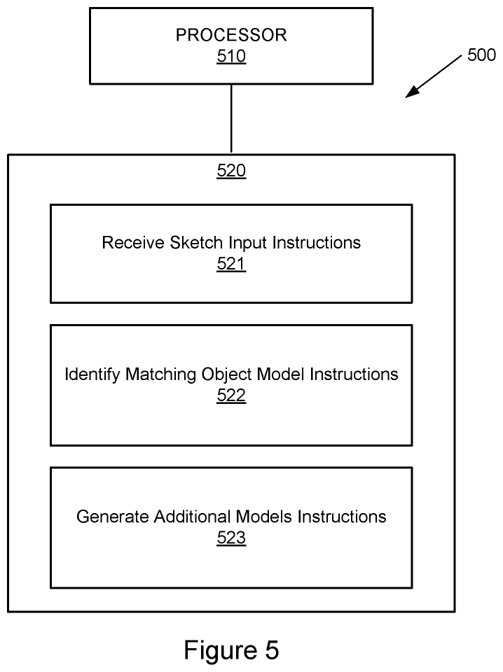

Referring now to FIG. 5, a block diagram of an example system is illustrated with a non-transitory computer-readable storage medium including instructions executable by a processor for particle categorizing. The system 500 includes a processor 510 and a non-transitory computer-readable storage medium 520. The computer-readable storage medium 520 includes example instructions 521-523 executable by the processor 510 to perform various functionalities described herein. In various examples, the non-transitory computer-readable storage medium 520 may be any of a variety of storage devices including, but not limited to, a random access memory (RAM) a dynamic RAM (DRAM), static RAM (SRAM), flash memory, read-only memory (ROM), programmable ROM (PROM), electrically erasable PROM (EEPROM), or the like. In various examples, the processor 510 may be a general purpose processor, special purpose logic, or the like.

The example instructions include receive sketch input instructions 521. In this regard, a sketch input may be received from a user through a sketch interface. As noted above, the sketch interface may be a two-dimensional input or a three-dimensional input.

The example instructions further include identify matching object model instructions 522. As described above, features may be extracted from the sketch input provided by the user. The extracted features may be compared with features of object models stored in a reservoir, and a best match may be identified.

The example instructions further include generate additional models instructions 523. As noted above, based on the match identified, additional models may be generated using, for example, an AI agent. In some examples, the additional models may be added to the reservoir of models.

Thus, various examples described above can allow a user to provide a sketch of a desired object to obtain a model (e.g., a voxel representation) of an object. Users with little or no expertise can generate such models since only a sketch input is used.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A system, comprising:
a sketch interface to receive a sketch input from a user;
an object model reservoir to store models of objects;
a generator to generate additional models of objects, the additional models to be added to the object model reservoir; and
a sample matching portion to select at least one matched object model from the reservoir to match to the sketch input from the user,
wherein the generator is to generate the additional models based on the matched object model.

2. The system of claim 1, wherein the object model reservoir is to store three-dimensional models of objects.

3. The system of claim 1, wherein the generator includes an artificial intelligence agent to generate the additional models.

4. The system of claim 3, wherein the artificial intelligent agent is to:
generate a vector representation of the matched object model; and
generate 3-D representations based on latent space around the vector representation.

5. The system of claim 4, wherein the artificial intelligence agent includes a discriminator to eliminate selected 3-D representations as unrealistic, the elimination being based on a confidence value generated by the discriminator.

6. The system of claim 1, wherein the sketch interface is a two-dimensional sketch input.

7. The system of claim 1, wherein the sketch interface is a three-dimensional sketch input.

8. The system of claim 7, wherein the three-dimensional sketch input includes a head-mounted display to provide visualization of a three-dimensional sketch.

9. A method, comprising:
(a) receiving a sketch input from a user through a sketch interface;
(b) identifying a matching object model for the sketch input from a reservoir of object models; and
(c) generating additional models of objects based on the matching object model.

10. The method of claim 9, further comprising:
(d) adding the additional models of objects to the reservoir; and
(e) identifying a new matching object model for the sketch input from the reservoir including the additional models.

11. The method of claim 10, further comprising:
iteratively repeating (c)-(e). A non-transitory computer-readable medium comprising instructions that, when executed by a processor, cause the processor to:
receive a sketch input from a user through a sketch interface;
identify a matching object model for the sketch input from a reservoir or object models; and
generate additional models of objects based on the matching object model.

13. The non-transitory computer-readable medium of claim 12, wherein the object model reservoir includes three-dimensional models of objects.

14. The non-transitory computer-readable medium of claim 12, wherein the generator includes an artificial intelligence agent to generate the additional models.

15. The non-transitory computer-readable medium of claim 14, wherein the artificial intelligent agent is to:
generate a vector representation of the matched object model; and
generate 3-D representations based on latent space around the vector representation.
